(19) United States
(12) Patent Application Publication
(10) Pub. No.: US 2006/0067495 A1
(43) Pub. Date: Mar. 30, 2006

(54) Information display device and information display program

(75) Inventor: Naoki Otsuka, Aichi-ken (JP)

Correspondence Address: BANNER & WITCOFF, LTD.;Counsel for Brother Industries, 1001 G STREET, N.W., 11TH FLOOR, WASHINGTON, DC, 20001-4597, US

(73) Assignee: BROTHER KOGYO KABUSHIKI KAISHA, Aichi-ken (JP)

(21) Appl. No.: 11/237,863

(22) Filed: Sep. 29, 2005

(30) Foreign Application Priority Data
Sep. 30, 2004 (JP) 2004-289132

(51) Int. Cl. H04M 15/06

(52) U.S. Cl. 379/142.01

(57) ABSTRACT

An information display device (for displaying identification information necessary for realizing communication via a network, for which a number of notational systems have been specified, in a prescribed display area on a display unit) includes a check unit which checks the size of the display area for displaying the identification information and an information display control unit which lets the display unit display the identification information in the display area in a notational system suitable for the size of the display area checked by the check unit.

### INCORPORATION BY REFERENCE

This application claims priority from Japanese Patent Application No. 2004-289132, filed on Sep. 30, 2004. The entire subject matter of the application is incorporated herein by reference thereto.

### BACKGROUND OF THE INVENTION

1. Technical Field

Aspects of the present invention relate to an information display device and an information display program for displaying identification information (information necessary for realizing communication via a network) in a prescribed display area on a display unit of a device.

2. Related Art

Data communication via a network is generally realized at present by use of IPv4 (Internet Protocol version 4) as a protocol in the network layer (the third layer in the OSI reference model), and, as is widely known, IPv6 (Internet Protocol version 6) as a successor protocol to IPv4 is going to be the mainstream.

Similarly to the case of IPv4, in order to enable a network device (hereinafter simply referred to as a “device”) to execute data communication via a network according to IPv6, various parameters such as identification information on the device itself (IP address) and identification information on a gateway server (the so-called “default gateway”) and a DNS (Domain Name System) server have to be set to the device properly. The setting of such identification information to a device is generally realized by displaying a screen for the setting (setting screen) on a display unit and thereafter letting a user enter each piece of identification information in each input window on the setting screen (see Japanese Patent Provisional Publication No. 2003-188900 (FIG. 3, etc.)).

Since the address space of such identification information is extended from 32 bits (IPv4) to 128 bits (IPv6), the problem of exhaustion of assignable identification information (IPv4 address exhaustion) will be resolved by the shift from IPv4 to IPv6. However, new problems (that do not occur to devices supporting IPv4 only) can occur to devices supporting IPv6 if the specifications for the setting of the identification information are not modified properly.

Identification information in IPv4 is expressed by decimal numbers which are separated in units of 8 bits. In IPv6, identification information is expressed by hexadecimal numbers separated in units of 16 bits so that the apparent number of characters can be reduced. However, the number of characters necessary for describing a piece of identification information in IPv6 is still as large as 32, which is far larger than that in IPv4 (at most 12).

Therefore, unless a sufficiently large display area (compatible with IPv6) is secured on the screen in the displaying of such identification information on the display unit, it may be impossible to display all the characters of the identification information at once, and the user incapable of checking the whole identification information at a glance (who can not see hidden part of the identification information) may have to move the characters in the display area by scrolling right/left, which can seriously impair the usability.

### SUMMARY OF THE INVENTION

The present invention which has been made in consideration of the above problems is advantageous in that an information display device and an information display program, capable of enhancing the usability when identification information is displayed on a screen, can be provided.

### BRIEF DESCRIPTION OF THE ACCOMPANYING DRAWINGS

FIG. 1 is a block diagram showing a network system employing an information display device in accordance with an embodiment of the present invention.

FIG. 2 is a flow chart showing the procedure of a manual setting process executed by a PC as the information display device in accordance with aspects of the invention.

FIG. 3 is a screen image showing an example of a list display screen displayed by the PC, in which each IPv6 address is displayed in a notational system “Long” in accordance with aspects of the invention.

FIG. 4A is a screen image showing a first screen as a subscreen of a setting screen displayed by the PC in accordance with aspects of the invention.

FIG. 4B is a screen image showing a second screen as another subscreen of the setting screen, in which an IPv6 address is displayed in the notational system “Long” in accordance with aspects of the invention.

FIG. 4C is a screen image showing an address form screen displayed by the PC in accordance with aspects of the invention.

FIG. 5 is a flow chart showing the procedure of an address form process executed by the PC in accordance with aspects of the invention.

FIGS. 6 and 7 are flow charts showing the procedure of a list display process executed by the PC in accordance with aspects of the invention.

FIGS. 8 and 9 are flow charts showing the procedure of an address display process executed by the PC in accordance with aspects of the invention.

FIG. 10A is a screen image showing another example of the list display screen, in which each IPv6 address is displayed in a notational system “Semi-long” in accordance with aspects of the invention.

FIG. 10B is a screen image showing another example of the list display screen, in which each IPv6 address is displayed in a notational system “Short” in accordance with aspects of the invention.

FIG. 10C is a screen image showing another example of the list display screen, in which each IPv6 address is displayed in two notational systems “Semi-long” and “Short” in accordance with aspects of the invention.

FIG. 11 is a flow chart showing the procedure of a parameter display process executed by the PC in accordance with aspects of the invention.

FIG. 12A is a screen image showing another example of the second screen, in which the IPv6 address is displayed in the notational system “Semi-long” in accordance with aspects of the invention.

FIG. 12B is a screen image showing another example of the second screen, in which the IPv6 address is displayed in the notational system “Short” in accordance with aspects of the invention.

FIG. 13 is a flow chart showing the manual setting process in accordance with another embodiment of the present invention.

FIG. 14 is a flow chart showing a modification of step S128 of the manual setting process of FIG. 2 in accordance with aspects of the invention.

FIG. 15 is a flow chart showing a setting incorporation process which can be executed by each printer in the network system in accordance with aspects of the invention.

### DETAILED DESCRIPTION

General Overview of the Invention

In accordance with an aspect of the present invention, there is provided a computer program product comprising computer-readable instructions that cause a device to execute an information display process comprising an information display step of displaying identification information necessary for realizing communication via a network (for which a number of notational systems have been specified) in a prescribed display area on a display unit. In the computer program product, the information display process includes a check step of checking the size of the display area for displaying the identification information, and the information display step displays the identification information in a notational system suitable for the size of the display area checked by the check step.

With the device controlled by the computer program product (information display program) configured as above, each piece of identification information can be displayed in a display area for the identification information in a notational system suitable for the size of the display area.

For example, IPv6 specifies a number of notational systems for describing each piece of identification information (IPv6 address) in a reduced number of characters. With such notational systems, even when the size of a display area for displaying identification information is insufficient for the maximum number of characters of the identification information, the whole identification information can be displayed inside the display area in most cases using such an abbreviated notational system.

Specifically, by employing a notational system of a higher compression ratio as the display area for the identification information gets smaller, all the characters forming the identification information can be displayed inside the display area without fail as long as the identification information is in a format allowing for the reduction of the number of characters by such compression ratios.

Therefore, the user, being consistently capable of checking all the characters of each piece of identification information at a glance, is relieved of the need of moving the identification information in the display area (by scrolling right/left) in order to view all the characters, by which the usability is enhanced considerably.

Incidentally, the “identification information” means information necessary for realizing communication via a network. The identification information include an IP address assigned to the device controlled by the computer program product, an IP address of a gateway (the so-called “default gateway”), an IP address of a DNS (Domain Name System) server for name resolution (and address resolution), an IP address of a mail server for managing the exchange of e-mails, etc.

The information display step may be configured to always employ the notational system suitable for the size of the display area checked by the check step for the displaying of the identification information. However, in cases where the identification information is displayed on the display unit together with other types of information, the user can intend to check these other types of information only. In such cases, fixing the notational system for the identification information at a particular system can be more convenient for the user who mainly checks those other types of information, rather than displaying all the characters of the identification information at once inside the display area. Such a request can be more earnest when the user changes and checks those other types of information far more frequently than the identification information.

To meet such a request, the computer program product may be configured as below.

The information display process may further include a first notation designation step of letting a user designate which one selected from the notational system suitable for the size checked by the check step and the specified notational systems should be used for displaying the identification information, and the information display step displays the identification information in the notational system designated in the first notation designation step.

With the above configuration, the displaying of the identification information in a notational system designated by the user becomes possible. For example, the user can previously designate the use of the notational system suitable for the size checked by the check step when the user is expecting to mainly check the identification information, while designating the use of a favorite notational system when the user is not expecting to mainly check the identification information. Therefore, a user interface capable of flexibly meeting various requirements of the user can be realized.

In this configuration, the information display step displays the identification information in the notational system suitable for the size checked by the check step only when the notational system designated in the first notation designation step is the “notational system suitable for the size checked by the check step”.

The check step is a step of checking the size of the display area for displaying the identification information. While the check step may simply check the size of the display area, the check step may also compare the size of the display area with that of each area necessary for displaying the identification information in each notational system.

Based on the comparison between the display area and the identification information (in each notational system) by the check step, if the size of the display area is larger than or equal to the sum of the sizes of two or more areas each of which is necessary for displaying the identification information in each notational system, the identification information may be displayed not in a single notational system but in two or more notational systems simultaneously. Therefore, the computer program product may be configured as below.

The information display step may be configured to display the identification information in two or more notational systems simultaneously in the display area when the size checked by the check step is larger than or equal to the sum of sizes of two or more areas each of which is necessary for displaying the identification information in each of the two or more notational systems.

With the above configuration, each piece of identification information can be displayed in two or more different notational systems simultaneously in the display area.

In this configuration, the simultaneous displaying of the identification information in two or more different notational systems may be carried out unexceptionally when the size of the display area is larger than or equal to the sum of sizes of the two or more necessary areas. However, some users may feel that the identification information displayed in a single notational system only is more convenient than the simultaneous displaying (additional displaying) for the checking of the identification information. To meet such a request, the computer program product may be configured as below.

The information display process may further include a simultaneous displaying designation step of letting a user designate whether to display the identification information in the display area for the identification information in two or more notational systems simultaneously or not, and the information display step displays the identification information in two or more notational systems simultaneously in the display area only when the simultaneous displaying of the identification information in two or more notational systems has been designated in the simultaneous displaying designation step.

With the above configuration, the user can arbitrarily change whether to display the identification information in a single notational system only or in two or more notational systems simultaneously, by changing the setting (designation) in the simultaneous displaying designation step, by which a user interface capable of flexibly meeting various requirements of the user can be realized.

The information display step is a step of displaying the identification information in a prescribed display area on the display unit. Specifically, the information display step may be configured as below.

The information display step may display a setting screen, used for setting various types of information including the identification information to the device, on the display unit, and the identification information assigned to the device is displayed by the information display step in a display area which is provided on the setting screen for displaying the identification information.

With the above configuration, the identification information assigned to the device can be displayed in the display area provided on the setting screen for displaying the identification information, in a notational system determined by the configurations described above.

The information display step may also be employed for displaying other types of screens. For example, the computer program product may be configured as below.

Preferably, the information display process further includes an information collection step of collecting various types of information (including the identification information assigned to other devices) from other devices capable of data communication with the device. The information display step displays a list display screen, for displaying the various types of information collected by the information collection step in a list format, on the display unit, and the identification information assigned to each of those other devices collected by the information collection step is displayed by the information display step in a display area which is provided on the list display screen for displaying the identification information on each of those other devices.

With the above configuration, the identification information assigned to each of those other devices can be displayed in each display area (provided on the list display screen for displaying the identification information on each of those other devices) in a notational system determined by the configurations described above.

In the case where the various types of information collected by the information collection step are displayed in a list format on the list display screen, the computer program product may be configured as below.

The check step may conduct the check on the display area regarding each of those other devices, and the information display step displays the identification information on each of those other devices collected by the information collection step in a notational system suitable for the result of the check by the check step regarding each device.

With the above configuration, the identification information assigned to each of those other devices can be displayed in each display area (provided on the list display screen for displaying the identification information on each of those other devices) in a notational system suitable for the result of the check by the check step regarding each device. Therefore, the pieces of identification information on those other devices can be displayed in notational systems different from one another.

In the case where the various types of information collected by the information collection step are displayed in a list format on the list display screen, the computer program product may also be configured as below.

The check step may conduct the check on the display area regarding each of those other devices, and the information display step displays the identification information on each of those other devices collected by the information collection step uniformly in one notational system capable of displaying the identification information in the smallest display area among the notational systems suitable for the results of the checks by the check step regarding those other devices.

With the above configuration, the identification information assigned to each of those other devices can be displayed in each display area (provided on the list display screen for displaying the identification information on each of those other devices) uniformly in one notational system capable of displaying the identification information in the smallest display area among the notational systems suitable for the results of the checks by the check step regarding those other devices, by which the user is allowed to see the whole identification information on all the devices at a glance, without the need of moving a piece of identification information in a display area by scrolling right/left.

In the case where the various types of information collected by the information collection step are displayed in a list format on the list display screen, the computer program product may also be configured as below.

The check step may conduct the check on the display area regarding each of those other devices. The information display process further includes a second notation designation step of letting a user designate whether the identification information on each of those other devices collected by the information collection step should be displayed in a notational system suitable for the result of the check by the check step regarding each device or uniformly in one notational system capable of displaying the identification information in the smallest display area among the notational systems suitable for the results of the checks by the check step regarding those other devices. The information display step displays the identification information on each of those other devices collected by the information collection step in the notational system designated in the second notation designation step.

With the above configuration, for the displaying of the identification information assigned to each of those other devices in each display area (provided on the list display screen for displaying the identification information on each of those other devices), the user is allowed to designate whether to display the identification information on each of those other devices in a notational system suitable for the result of the check by the check step regarding each device (that is, to display pieces of identification information on those other devices in notational systems different from one another) or uniformly in one notational system capable of displaying the identification information in the smallest display area among the notational systems suitable for the results of the checks by the check step regarding those other devices.

Incidentally, in the case where the check on the display area is conducted regarding each of those other devices, the check step may be configured to conduct the check regarding each display area (for displaying each piece of identification information on each device) as described above. However, when all the display areas (for displaying the pieces of identification information on those other devices) arranged in a list format have exactly the same size, the check is not necessary for all the display areas; the check may be executed for at least one of the display areas.

In the case where the various types of information collected by the information collection step are displayed in a list format on the list display screen, the computer program product may also be configured as below.

The list display screen may be configured so that the size of each display area for displaying each piece of the identification information can be changed arbitrarily according to an operation by a user. The information display process further includes a resizing detection step of detecting a change in the size of a display area on the list display screen for displaying the identification information. The check on the display areas by the check step and the displaying of the identification information by the information display step are redone when a change is detected by the resizing detection step.

With the above configuration, the check by the check step and the displaying of the identification information by the information display step are redone each time a change in the size of a display area (for displaying the identification information) on the list display screen is detected by the resizing detection step, by which the identification information can be redisplayed in appropriate notational systems on every resizing operation by the user.

Each information display program (computer program product) described above, made of a sequence of instructions (suitable for processing by a computer) arranged in a proper order, can be supplied to a device or a user of the device via a record medium (FD, CD-ROM, memory card, etc.) or a communication line/network (e.g. the Internet). Each information display program may also be provided to a user by preinstalling the program in a hard disk or memory of a device.

In accordance with another aspect of the present invention, there is provided an information display device for displaying identification information necessary for realizing communication via a network, for which a number of notational systems have been specified, in a prescribed display area on a display unit. The information display device includes a check unit which checks the size of the display area for displaying the identification information and an information display control unit which lets the display unit display the identification information in the display area in a notational system suitable for the size of the display area checked by the check unit.

With the information display device configured as above, each piece of identification information can be displayed in a display area for the identification information in a notational system suitable for the size of the display area. Therefore, the whole identification information can be displayed inside the display area without being hidden, and the user, being consistently capable of checking all the characters of each piece of identification information at a glance, is relieved of the need of moving the identification information in the display area (by scrolling right/left) in order to view all the characters, by which the usability is enhanced considerably.

In accordance with another aspect of the present invention, there is provided an information display method for displaying identification information necessary for realizing communication via a network, for which a number of notational systems have been specified, in a prescribed display area on a display unit. The information display method includes a check step of checking the size of the display area for displaying the identification information and an information display step of letting the display unit display the identification information in the display area in a notational system suitable for the size of the display area checked by the check unit.

With the information display method configured as above, effects similar to those of the above information display device can be achieved.

It is noted that various connections are set forth between elements in the following description. It is noted that these connections in general and, unless specified otherwise, may be direct or indirect and that this specification is not intended to be limiting in this respect.

### Embodiment

Referring now to the drawings, a description will be given in detail of preferred embodiments in accordance with the present invention.

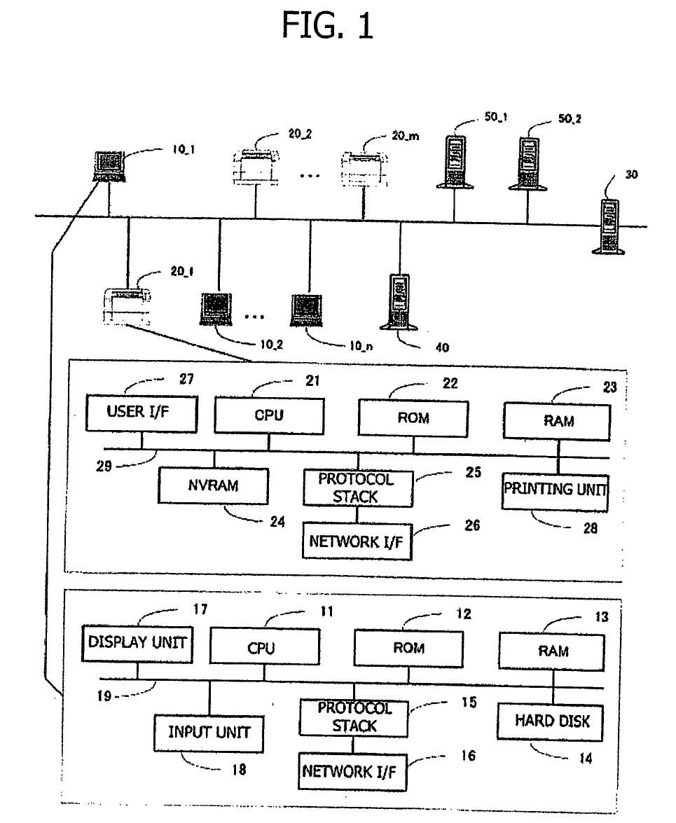

FIG. 1 is a block diagram showing a network system employing an information display device in accordance with an embodiment of the present invention. As shown in FIG. 1, a number of PCs 10 (Personal Computers 10_1-10_n), a number of printers 20 (20_1-20_m), a gateway 30, a mail server 40, a primary DNS (Domain Name System) server 50_1, a secondary DNS server 50_2, etc. are connected together by a network to be capable of data communication.

Each PC 10 is a computer system of a well-known type, including a CPU (Central Processing Unit) 11, a ROM (Read Only Memory) 12, a RAM (Random Access Memory) 13, a hard disk 14, a protocol stack 15, a network interface (network I/F) 16, a display unit 17, an input unit 18, etc. which are connected together by a bus 19. Each PC 10 functions as a network device when it is connected to the network via the network I/F 16.

While the protocol stack 15 is shown in FIG. 1 as a component connecting the network I/F 16 to the bus 19, the protocol stack 15 in FIG. 1 is only a symbol conceptualizing a state in which data communication by the network I/F 16 is realized by processes according to the protocol stack 15. Actually, the protocol stack 15 is a program module installed (stored) in the hard disk 14 for implementing data communication according to both IPv4 (Internet Protocol version 4) and IPv6 (Internet Protocol version 6).

Among the PCs 10, the PC 10_1 is equipped with a setting management program and an information display program for executing various processes which will be explained later, by which the PC 10_1 functions as an information display device in accordance with the present invention.

Each printer 20 is a network printer of a well-known type, including a CPU 21, a ROM 22, a RAM 23, an NVRAM (Non Volatile RAM) 24, a protocol stack 25, a network interface (network I/F) 26, a user interface (user I/F) 27, a printing unit 28, etc. which are connected by a bus 29. Each printer 20 functions as a network device when it is connected to the network via the network I/F 26.

The protocol stack 25 is a program module stored in the NVRAM 24, similarly to the protocol stack 15 of each PC 10.

In order to enable each network device (PC 10, printer 20) to execute data communication via the network, an IP address for uniquely identifying the device in the network has to be set (assigned) to the device. Incidentally, while only one IP address can be assigned to a device in IPv4, IPv6 has no such restriction and a number of IP addresses can be assigned to a device.

Irrespective of whether the IP protocol is IPv4 or IPv6, IP addresses can be assigned to devices either by the manual setting function or by the automatic setting function. The manual setting (static setting) is carried out according to the setting management program of the PC 10_1 as will be explained later. Meanwhile, the automatic setting includes two setting functions: “stateful address setting” in which a device obtains an IP address from a DHCP (Dynamic Host Configuration Protocol) server and sets the obtained IP address as its own IP address and “stateless address setting” in which a device generates an IP address (based on a MAC address assigned to its network I/F (16, 26) and information (prefix) which has been preset or which is obtained from a router (not shown), etc. on the network) and sets the generated IP address as its own IP address. While only the stateful address setting can be employed in IPv4, both the stateful address setting and the stateless address setting can be employed in IPv6.

The mail server 40 has functions as an SMTP (Simple Mail Transport Protocol) server and a POP (Post Office Protocol) server.

(1) Manual Setting Process

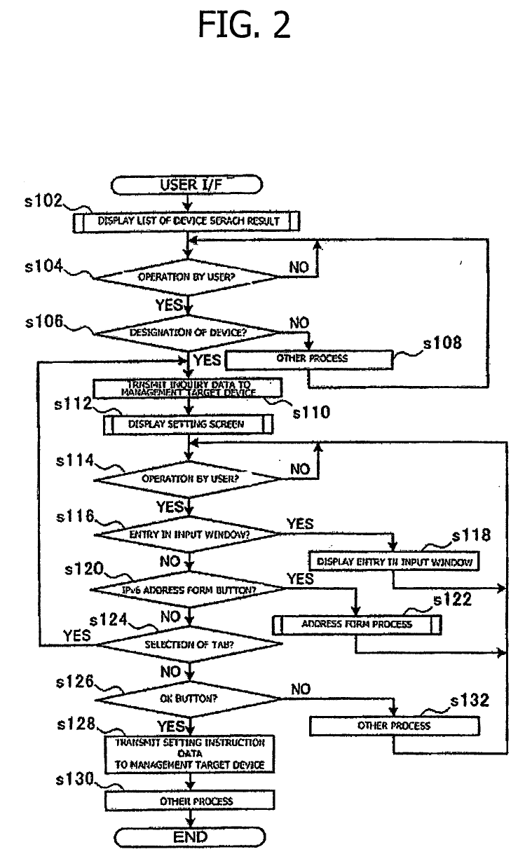

First, a manual setting process executed by (the CPU 11 of) the PC 10_1 will be explained in detail referring to a flow chart of FIG. 2. The PC 10_1 executes the manual setting process according to the aforementioned setting management program.

First, the PC 10_1 searches for devices existing on the network and displays a list of the result of the device search on the display unit 17 (S102). In the step S102 which is executed when the aforementioned information display program is activated, the PC 10_1 displays a list display screen (on which pieces of information obtained from the devices are arranged in a list format in regard to each device (Node Name)) on the display unit 17. The details of the step S102 will be described later in an explanation of a “list display process”. After the list display screen has been displayed as above, the user can perform various operations (e.g. designating one of the devices in the list) through the input unit 18.

After displaying the list display screen, the PC 10_1 waits for an operation by the user on the input unit 18 (S104: NO). When an operation is performed by the user (S104: YES), if the operation is the designation of a device (S106: YES), the PC 10_1 inquires of the designated device (hereinafter referred to as a “management target device” (one of the printers in this embodiment)) about its setting information (S110). In this step, the PC 10_1 transmits inquiry data to the management target device in order to inquire about information corresponding to a subscreen of a setting screen (to be displayed in the following step S112) as the setting information on the management target device. The management target device receiving the inquiry data sends back setting data which indicates the setting information. When information inquired by the inquiry data has not been set to the management target device yet, the management target device sends back setting data that can specify that the information has not been set yet (void parameter, etc.). On the other hand, if the operation by the user after the list display screen is displayed is not the designation of a device (S106: NO), the PC 10_1 executes a process corresponding to the operation (other process) (S108) and thereafter returns to S104.

Based on the setting data from the management target device in response to the inquiry of S110, the PC 10_1 displays the setting screen (which is used for setting parameters to the management target device (remote setup)) on the display unit (S112). The setting screen includes a number of subscreens each of which has a tab. By selecting a tab, the subscreen being displayed can be switched, by which a subscreen corresponding to the selected tab (having input windows used for entering parameters corresponding to a function specific to the subscreen) is displayed on the display unit 17. The details of the step S112 will be described later in an explanation of a “parameter display process”.

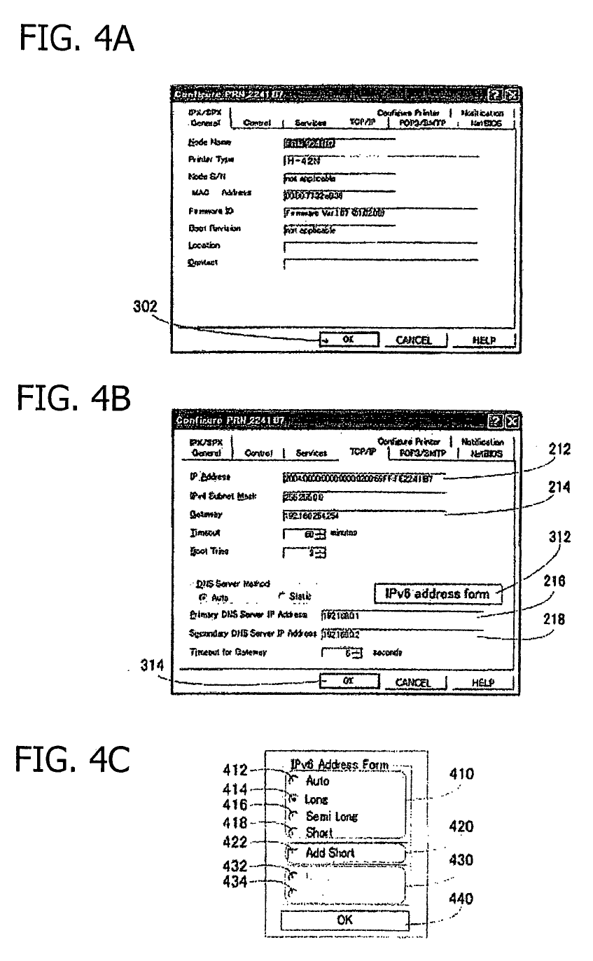

The subscreens of the setting screen include a first screen (see FIG. 4A) for displaying information unique to the management target device. The first screen is displayed when the step S110 is executed for the first time since the start of the manual setting process. From other subscreens, the first screen can be called up by selecting a “General” tab. The “information unique to the management target device” includes the device name (Node Name) obtained in the aforementioned step S102, the MAC address assigned to the network I/F 26 of the management target device, etc. Incidentally, the aforementioned “information” corresponding to the first screen includes the device name (Node Name) of the management target device, etc. The inquiry data transmitted in the step S110 inquires about parameters such as the device name.

The subscreens of the setting screen further include a second screen (see FIG. 4B) which is displayed when a “TCP/IP” tab is selected. On the second screen, various parameters necessary for realizing data communication via the network can be set, such as an IP address assigned to the device, an IP address of the gateway 30 (the so-called “default gateway”) and IP addresses of the primary DNS server 50_1 and the secondary DNS server 50_2. The second screen has input windows 212-218 used for entering the above IP addresses, etc. The second screen is also provided with an IPv6 address form button 312 for letting the PC 10_1 display an “IPv6 address form screen” which is used for making settings regarding the notation of IPv6 addresses. When the user performs an operation for selecting the IPv6 address form button 312 (hereinafter simply described as “presses” the IPv6 address form button 312, ditto for other buttons), an “address form process” is executed as will be explained later. Incidentally, the aforementioned “information” corresponding to the second screen includes parameters such as the above IP addresses (excluding parameters regarding the “address form process”). The inquiry data transmitted in the step S110 inquires about these parameters.

After the setting screen has been displayed as above, the user can perform an operation for selecting a tab, an operation for inputting a parameter in each input window, an operation for selecting the IPv6 address form button 312, an operation for selecting an OK button 302/314, etc. through the input unit 18.

After displaying the setting screen in the step S112, the PC 10_1 waits for an operation by the user on the input unit 18 (S114: NO). When an operation is performed by the user (S114: YES), whether the operation is an entry in an input window or not is judged (S116). If the operation is an entry in an input window (S116: YES), the entry (entered parameter) is displayed (incorporated) in the input window (S118) and thereafter the process returns to the step S114.

If the operation by the user is the pressing of the IPv6 address form button 312 (S116: N0, S120: YES), the “address form process” (explained later) is executed (S122) and thereafter the process returns to the step S114. The address form process is a process for letting the user designate the notation of IPv6 addresses. The details of the address form process will be explained later.

If the operation by the user is a selection of a tab for switching the subscreen of the setting screen (S120: N0, S124: YES), the process returns to the step S110, in which the inquiry data (inquiring about the setting information corresponding to the screen to be displayed in the next step S112 (subscreen corresponding to the selected tab)) is transmitted to the management target device as explained above. Thereafter, the setting screen (subscreen) corresponding to the selected tab is displayed (S112).

After the repetition of the loop of S110-S124, if the operation by the user in the step S114 is the pressing of an OK button on any one of the subscreens of the setting screen (S124: N0, S126: YES), setting instruction data (for instructing the management target device to set the parameters which have been entered in the input windows of all the subscreens of the setting screen, excluding parameters regarding the address form process) is transmitted to the management target device (S128), the setting screen and the list display screen are erased, and thereafter the manual setting process of FIG. 2 is ended. The management target device receiving the setting instruction data sets the parameters to itself or updates parameters already set to itself based on the setting instruction data. Incidentally, while the manual setting process of FIG. 2 is ended after the transmission of the setting instruction data in this embodiment, it is also possible to configure the manual setting process to return to the step S102 after the transmission of the setting instruction data (S128) unless a prescribed operation for ending the manual setting process is preformed by the user, in order to repeat the setting instruction for a number of management target devices.

If the operation by the user in the step S114 is none of the above operations (S124: NO, S126: NO), the PC 10_1 executes a process corresponding to the operation (other process) (S132) and thereafter returns to S114. While the manual setting process explained above is actually configured to erase the setting screen and the list display screen and return to the step S102 also when a “Cancel” button on any one of the subscreens of the setting screen is pressed, detailed explanation of the operation (not important for the understanding of the present invention) is omitted here.

(2) Address Form Process

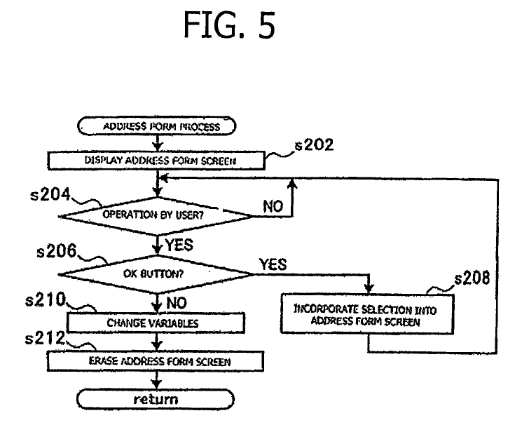

In the following, the details of the address form process (S112 of FIG. 2) will be explained referring to a flow chart of FIG. 5.

Since the address form process is a process for making settings regarding the notation of IPv6 addresses, some notational systems for IPv6 addresses will be explained here. Since an IPv6 address (IP address according to IPv6) has a 128-bit address space which is far larger than the 32-bit address space of an IPv4 address, each IPv6 address is expressed by hexadecimal numbers separated in units of 16 bits so that the apparent number of characters can be reduced. However, the IPv6 address in this format can not be regarded as sufficiently short since the maximum number of characters is as large as 32 (far larger than 12 of the IPv4 address). Therefore, some notational systems for IPv6 addresses for reducing the number of characters have been specified in addition to the original notational system using hexadecimal numbers separated in units of 16 bits (hereinafter referred to as “Long”). Such abbreviated notational systems include a system omitting “0”s in each 16-bit block except for the rear end of the 16-bit block (hereinafter referred to as “Semi-long”), a system expressing consecutive 16-bit blocks made exclusively of “0”s as “::” (hereinafter referred to as “Short”), etc. In the address form process, a notational system to be used for displaying IPv6 addresses is set by receiving an operation by the user.

First, the PC 10_1 displays the address form screen (IPv6 address form screen) on the display unit 17 (S202). The address form screen is a screen used for determining which of the notational systems should be used for displaying IPv6 addresses in the steps S102 and S112 of FIG. 2. As shown in FIG. 4C, the address form screen includes first through third areas 410-430 (each of which has at least a radio button or check box), an OK button 440, etc. Incidentally, the selection status of the radio buttons and the check box on the address form screen corresponds to values of a “notification system setting variable”, a “unification setting variable” and an “additional displaying setting variable” which will be explained later.

The first area 410 of the address form screen includes radio buttons such as an “Auto” button 412 (for letting the PC 10_1 display each IPv6 address in a notational system determined automatically in subsequent steps), a “Long” button 414 (for letting the PC 10_1 display IPv6 addresses in the notational system “Long”), a “Semi-Long” button 416 (for letting the PC 10_1 display IPv6 addresses in the notational system “Semi-long”) and a “Short” button 418 (for letting the PC 10_1 display IPv6 addresses in the notational system “Short”). The second area 420 includes a check box 422 for letting the PC 10_1 display each IPv6 address in a number of notational systems simultaneously (side by side or in parallel) in each display area when the display area is large enough. The third area 430 includes radio buttons such as a “Unify” button 432 (for letting the PC 10_1 display IPv6 addresses uniformly in the same notational system on the list display screen in the step S102 of FIG. 2) and a “Justify” button 434 (for letting the PC 10_1 display IPv6 addresses not uniformly on the list display screen). Incidentally, the radio buttons in the third area 430 become active (selectable) only when the “Auto” button 412 in the first area 410 has been selected.

After the address form screen has been displayed on the display unit 17 as above, the user can perform an operation for selecting a radio button, an operation for selecting (checking) the check box 422, etc. through the input unit 18.

After displaying the address form screen as above, the PC 10_1 waits for an operation by the user (S204: NO). When an operation is performed by the user (S204: YES), if the operation is not the pressing of the OK button 440, that is, if the operation is a selection of a radio button or the check box 422 (S206: NO), the PC 10_1 incorporates the selection into the address form screen (S208) and returns to the step S204. The “incorporating the selection into the address form screen” means the following operation. When a radio button in the first area 410 or 430 is selected, the PC 10_1 sets the selected button in a selected state while setting other button(s) in the area in a non-selected state. When the check box 422 in the second area 420 is selected, the PC 10_1 switches the check box to a checked state (to a non-checked state when the check box has already been checked).

If the operation by the user is the pressing of the OK button 440 (S206: YES), the PC 10_1 changes its variables corresponding to the areas 410-430 on the address form screen (S210). First, as a variable corresponding to the first area 410, a “notification system setting variable” indicating the notational system for IPv6 addresses (“Auto” in the initial state) is set to “Auto” (when the “Auto” button 412 is selected), “Long” (when the “Long” button 414 is selected), “Semi-Long” (when the “Semi-Long” button 416 is selected), or “Short” (when the “Short” button 418 is selected). As a variable corresponding to the second area 420, an “additional displaying setting variable” indicating whether or not to display an IPv6 address in a number of notational systems simultaneously in a display area (“null” in the initial state) is set to “Add” (when the check box 422 is selected) or “null” (when the check box 422 is not selected). As a variable corresponding to the third area 430, a “unification setting variable” indicating whether or not to display IPv6 addresses uniformly in the same notational system on the list display screen (“Justify” in the initial state) is set to “Unify” (when the “Unify” button 432 is selected) or “Justify” (when the “Justify” button 434 is selected).

Thereafter, the PC 10_1 erases the address form screen (S212) and returns to the step S114 of FIG. 2.

(3) List Display Process

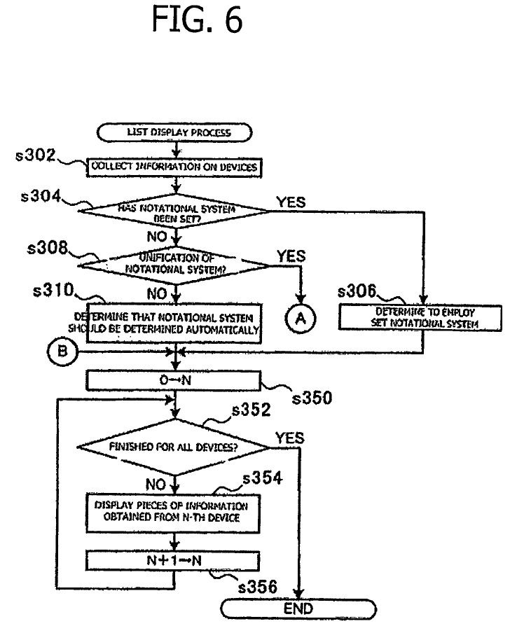

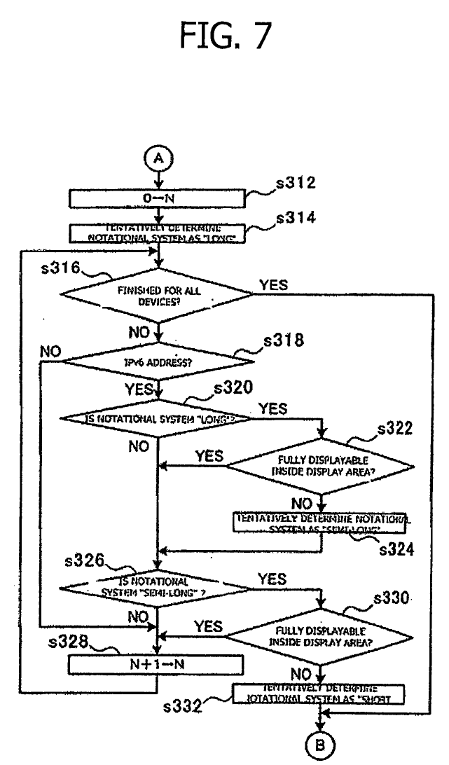

In the following, the details of the list display process (S102 of FIG. 2) will be explained referring to flow charts of FIGS. 6 and 7.

First, the PC 10_1 collects information on devices existing on the network (S302). In this step, the PC 10_1 transmits (broadcast & multicast) request data (for requesting devices on the network to send back general information) according to IPv4 and IPv6. The “general information” means information that has been set to each device, such as the name of the device (Node Name) and an IP address of the device (Node Address). The PC 10_1 collects information returned from devices receiving the request data (the printers 20 in this embodiment) for a prescribed time period.

Subsequently, the PC 10_1 checks whether a notational system for IPv6 addresses (hereinafter also referred to simply as “IP addresses”) has been set or not (S304). In this step, the PC 10_1 judges that a notational system has been set if the notification system setting variable has been set to a value other than “null”.

If a notational system has been set (S304: YES), the PC 10_1 determines a notational system to be used for displaying IP addresses in a subsequent step (namely, in step S354) to be the notational system set by the user, that is, determines to employ the notational system (set by the user) for displaying IP addresses in the subsequent step (S306), and thereafter advances to step S350. In the step S306, the notational system to be used for displaying IP addresses in the subsequent step (S354) is determined to be the notational system set by the user, by setting a “notification system determination variable” (which will be referred to for determining the notational system for displaying IP addresses in the subsequent step) at (to be equal to) the aforementioned notification system setting variable. Incidentally, the notification system determination variable is set to “Auto” (initial value) each time the list display process is started.

On the other hand, if no notational system has been set (S304: NO), the PC 10_1 checks whether the setting for unifying the notational system for IP addresses has been made or not (S308). In this step, the PC 101 judges that the setting for the unification has been made if the “unification setting variable” has been set to “Unify”.

If the setting for the unification has not been made (S308: NO), the PC 10_1 determines that the notational system for displaying each IP address in the subsequent step should be determined automatically (S310) and thereafter advances to the step S350. In the step S310, the PC 10_1 makes the determination by setting the notification system determination variable to “Auto”.

If the setting for the unification has been made (S308: YES), the PC 10_1 employs one of the notational systems as the notational system for all the IP addresses to be displayed in the subsequent step, by executing steps S312-S332 shown in FIG. 7.

Referring to FIG. 7, the PC 10_1 first initializes a device number N to “0” (S312) and tentatively determines the notational system to be used for displaying IP addresses in the subsequent step as “Long” (S314). In this step, the notational system is determined tentatively by setting the notification system determination variable to “Long”. Incidentally, the device number “N” will be used in the following explanation for expressing each of information source devices (the devices from which the information was obtained in the step S302).

Subsequently, the PC 10_1 checks whether the following loop (S318-S330) has been finished for all the information source devices or not (S316). In this step, the loop is judged to have been finished for all the information source devices if the device number N has reached the total number of the information source devices.

If the loop has not been finished for all the information source devices (S316: NO), the PC 10_1 checks whether the IP address assigned to the N-th information source device (contained in the information obtained from the device in S302) is an IPv6 address or not (S318). In this step, whether the IP address (precisely, a character string indicating an IP address) is an IPv6 address or not is judged by checking whether the character string includes an improper character or not, whether the character string is made up of a proper number of characters or not, etc. Specifically, the check is carried out by calculating a standard function “ret=inet_pton (af_inet6, ipstring, dst)” of POSIX, by substituting the character string indicating the IP address (assigned to the N-th information source device) into the variable “ipstring”. The function returns a “negative” value when the “ipstring” is not a character string indicating an IP address in the IPv6 format, while returning a “positive” value when the “ipstring” is a character string indicating an IP address in the IPv6 format (a correct character string). Therefore, the PC 10_1 judges that the character string indicating an IP address is an IPv6 address when a “positive” value is returned by the function.

If the character string is judged to be an IPv6 address (S318: YES), the PC 10_1 checks whether the notational system which has been determined tentatively (i.e. the value of the notification system determination variable) is “Long” or not (S320).

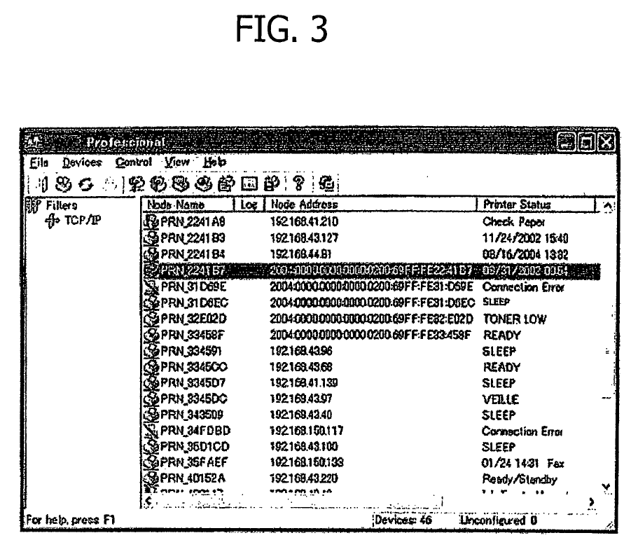

If the tentatively determined notational system is “Long” (S320: YES), the PC 10_1 checks whether or not the whole IP address (IPv6 address) of the N-th information source device can be displayed inside a display area (for displaying the IP address in a subsequent step) in the notational system “Long” (S322). If the whole IP address can not be displayed inside the display area (S322: NO), the PC 10_1 tentatively determines the notational system as “Semi-long”, that is, sets the notification system determination variable to “Semi-long” (S324), and thereafter advances to the next step S326. On the other hand, if the whole IP address can be displayed inside the display area (S322: YES), the PC 10_1 advances to the step S326 without executing the step S324. Incidentally, the check of S322 is carried out by comparing the size of the display area for displaying the IP address in a subsequent step (i.e. the width of the “Node Address” area in FIG. 3) with that of an area necessary for displaying the IP address of the N-th information source device.

If the tentatively determined notational system is not “Long” in the step S320 (S320: NO), the PC 10_1 advances to the step S326 without executing the steps S322 and S324.

In the step S326, the PC 10_1 checks whether the tentatively determined notational system (i.e. the value of the notification system determination variable) is “Semi-long” or not.

If the tentatively determined notational system is not “Semi-long” (S326: NO), the PC 10_1 increments the device number N by 1 (S328) and returns to the step S316. If the tentatively determined notational system is “Semi-long” (S326: YES), the PC 10_1 checks whether or not the whole IP address of the N-th information source device can be displayed inside the display area (for displaying the IP address in the subsequent step) in the notational system “Semi-long” (S330). If the whole IP address can not be displayed inside the display area (S330: NO), the PC 10_1 tentatively determines the notational system as “Short”, that is, sets the notification system determination variable to “Short” (S332), by which the notational system to be used for displaying all the IP addresses in the subsequent step is determined (finalized) as “Short”. Thereafter, the PC 10_1 advances to step S350 of FIG. 6. On the other hand, if the whole IP address can be displayed inside the display area (S330: YES), the PC 10_1 increments the device number N by 1 (S328) and returns to the step S316. Incidentally, the check of S330 is carried out similarly to the check of S322.

After the repetition of the loop of S316-S330, when the loop has been finished for all the information source devices (S316: YES), the PC 10_1 exits the loop, by which the notational system to be used for displaying all the IP addresses in the subsequent step (S354) is determined (finalized) as the notational system tentatively determined so far in the steps S312-S332. Thereafter, the PC 10_1 advances to the step S350 of FIG. 6.

In the process from the step S350 of FIG. 6, the PC 10_1 first initializes the device number N to “0” (S350) similarly to S312 of FIG. 7, and thereafter checks whether the following loop (S354, S356) has been finished for all the information source devices (devices from which the information was obtained in S302) or not (S352) similarly to S316 of FIG. 7.

If the loop has not been finished for all the information source devices (S352: NO), the PC 10_1 displays pieces of information obtained from the N-th information source device in the step S302, arranging them horizontally on the list display screen shown in FIG. 3 (S354). In this step, the pieces of information obtained from the N-th information source device are successively entered in corresponding display areas, in which the IP address is displayed according to an “address display process” which will be explained below.

Subsequently, the PC 10_1 increments the device number N by 1 (S356) and returns to the step S352.

After the repetition of the loop of S354-S356, when the loop has been finished for all the information source devices, that is, when the information on all the information source devices has been displayed on the list display screen in the tabular format (S352: YES), the list display process of FIGS. 6 and 7 is ended.

(4) Address Display Process

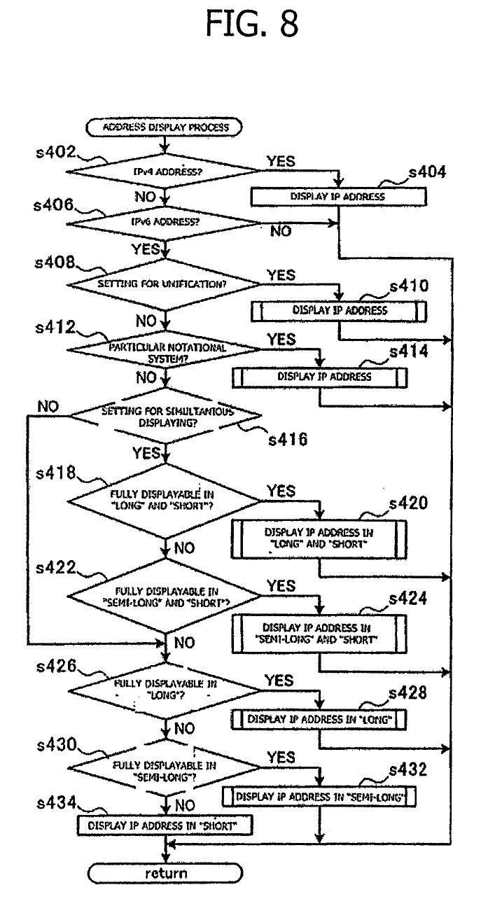

In the following, the address display process, which is executed when an IP address (as one of the pieces of information obtained from the N-th information source device) is displayed on the list display screen in the step S354 of FIG. 6, will be explained in detail referring to a flow chart of FIG. 8.

First, the PC 10_1 checks whether the IP address to be displayed is an IPv4 address (IP address according to IPv4) or not (S402). In this step, whether the IP address (precisely, a character string indicating an IP address) is an IPv4 address or not is judged by checking whether the character string includes an improper character or not, whether the character string is made up of a proper number of characters or not, etc.

If the IP address is judged to be an IPv4 address (S402: YES), the PC 10_1 directly displays the IP address (IPv4 address) in a corresponding display area (S404), ends the address display process, and advances to the step S356 of FIG. 6.

If the IP address is judged not to be an IPv4 address (S402: NO), the PC 10_1 checks whether the IP address is an IPv6 address (IP address according to IPv6) or not (S406). In this step, the check is carried out similarly to the aforementioned check of S318 of FIG. 7.

If the IP address is judged not to be an IPv6 address (S406: NO), the PC 10_1 ends the address display process without displaying the IP address, and thereafter advances to the step S356 of FIG. 6.

If the IP address is judged to be an IPv6 address (S406: YES), the PC 10_1 checks whether the setting for displaying IPv6 addresses uniformly in the same notational system on the list display screen has been made or not (S408). In this step, the PC 10_1 judges that the setting for the unification has been made if the notification system determination variable has been set to “Auto” and the unification setting variable has been set to “Unify”.

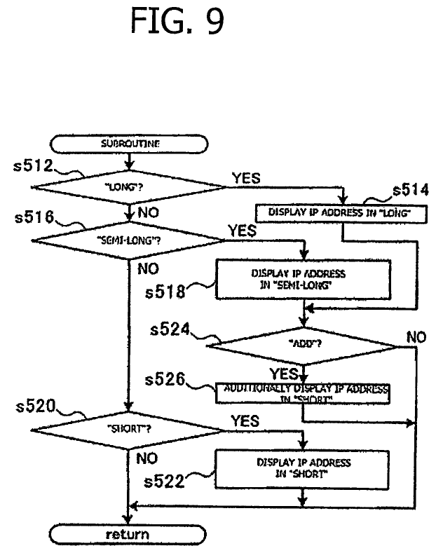

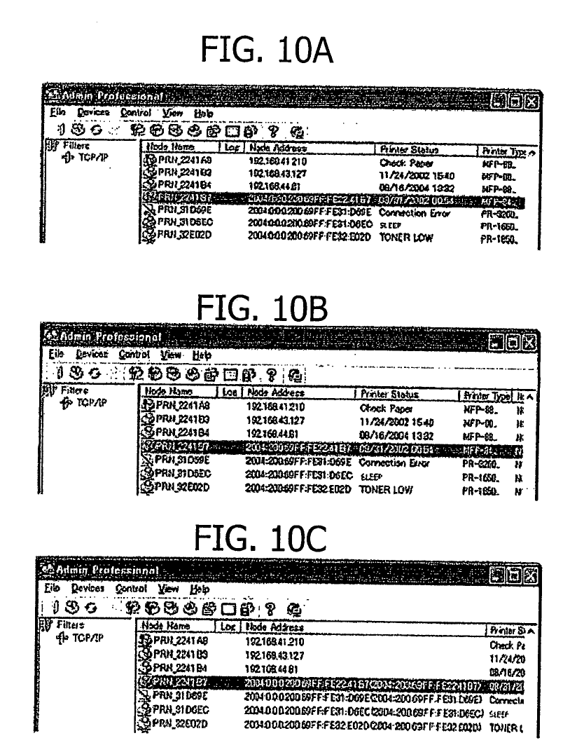

If the setting for the unification has been made (S408: YES), the IP address to be displayed is displayed on the list display screen on the display unit 17 according to the notational system that has been set (determined) at this point (S410). In this step, the PC 10_1 calls up a subroutine shown in FIG. 9 with current values of the notification system determination variable and the additional displaying setting variable as arguments, displays the IP address in a notational system corresponding to the two arguments, and thereafter advances to the step S356 of FIG. 6. In the subroutine of FIG. 9, if the argument regarding the notification system determination variable is “Long” (S512: YES), the PC 10_1 displays the IP address in the notational system “Long” as shown in FIG. 3 (S514). If the argument is “Semi-long” (S512: N0, S516: YES), the PC 10_1 displays the IP address in the notational system “Semi-long” as shown in FIG. 10A (S518). If the argument is “Short” (S516: N0, S520: YES), the PC 10_1 displays the IP address in the notational system “Short” as shown in FIG. 10B (S522) and thereafter advances to the step S356 of FIG. 6. In the case where the IP address has been displayed in “Long” or “Semi-long” (S514, S518), if the argument regarding the additional displaying setting variable is “Add” (S524: YES), the PC 10_1 further displays the IP address in the notational system “Short” and in parentheses after the IP address displayed in the step S514 or S518 as shown in FIG. 10C (S526), and thereafter advances to the step S356 of FIG. 6. Incidentally, FIG. 10C shows an example in which the IP address is displayed in “Semi-long” and “Short”. On the other hand, if the argument regarding the additional displaying setting variable is “null” (S524: NO), the PC 10_1 advances to the step S356 of FIG. 6 without executing the step S526.

Returning to FIG. 8, if the setting for the unification has not been made (S408: NO), the PC 10_1 checks whether a setting for displaying IPv6 addresses in a particular notational system has been made or not (S412). In this step, the PC 10_1 judges that such a setting has been made if the notification system determination variable has been set to a value other than “Auto”.

If the setting for displaying IPv6 addresses in a particular notational system has been made (S412: YES), the PC 10_1 displays the IP address on the list display screen on the display unit 17 in the particular notational system that has been set (S414). In this step, similarly to the step S410, the PC 10_1 calls up the subroutine of FIG. 9 with current values of the notification system determination variable and the additional displaying setting variable as arguments, displays the IP address in a notational system corresponding to the two arguments, and thereafter advances to the step S356 of FIG. 6.

On the other hand, if no setting for displaying IPv6 addresses in a particular notational system has been made (S412: NO), the PC 10_1 checks whether the setting for displaying an IPv6 address in a number of notational systems simultaneously in a display area has been made or not (S416). In this step, the PC 10_1 judges that the setting has been made if the additional displaying setting variable has been set to “Add”.

If the setting for displaying an IPv6 address in a number of notational systems simultaneously has been made (S416: YES), the PC 10_1 checks whether or not the IP address (IPv6 address) of the N-th information source device can be fully displayed inside the display area both in the notational systems “Long” and “Short” simultaneously (S418).

If the simultaneous displaying (additional displaying) in “Long” and “Short” inside the display area is judged to be possible (S418: YES), the PC 10_1 displays the IP address in the display area both in “Long” and “Short” simultaneously (S420). In this step, the PC 10_1 displays the IP address by calling up the subroutine of FIG. 9 and thereafter advances to the step S356 of FIG. 6 similarly to the step S410, except that the subroutine is called up with an argument “Long” as the argument regarding the notification system determination variable irrespective of the current value of the notification system determination variable.

If the simultaneous displaying in “Long” and “Short” inside the display area is judged to be impossible (S418: NO), the PC 10_1 checks whether or not the IP address can be fully displayed inside the display area both in the notational systems “Semi-long” and “Short” simultaneously (S422).

If the simultaneous displaying in “Semi-long” and “Short” inside the display area is judged to be possible (S422: YES), the PC 10_1 displays the IP address in the display area both in “Long” and “Short” simultaneously (S424). In this step, the PC 10_1 displays the IP address by calling up the subroutine of FIG. 9 and thereafter advances to the step S356 of FIG. 6 similarly to the step S410, except that the subroutine is called up with an argument “Semi-long” as the argument regarding the notification system determination variable irrespective of the current value of the notification system determination variable.

If the simultaneous displaying in “Semi-long” and “Short” inside the display area is judged to be impossible in S422 (S422: NO) or if the setting for displaying an IPv6 address in a number of notational systems simultaneously has not been made in S416 (S416: NO), the PC 10_1 checks whether or not the whole IP address can be displayed inside the display area in the notational system “Long” (S426).

If the displaying of the IP address in “Long” inside the display area is judged to be possible (S426: YES), the PC 10_1 displays the IP address in the display area in the notational system “Long” (S428). In this step, the PC 10_1 displays the IP address by calling up the subroutine of FIG. 9 and thereafter advances to the step S356 of FIG. 6 similarly to the step S410, except that the subroutine is called up with an argument “Long” as the argument regarding the notification system determination variable irrespective of the current value of the notification system determination variable.

If the displaying of the IP address in “Long” inside the display area is judged to be impossible (S426: NO), the PC 10_1 checks whether or not the whole IP address can be displayed inside the display area in the notational system “Semi-long” (S430).

If the displaying of the IP address in “Semi-long” inside the display area is judged to be possible (S430: YES), the PC 10_1 displays the IP address in the display area in the notational system “Semi-long” (S432). In this step, the PC 10_1 displays the IP address by calling up the subroutine of FIG. 9 and thereafter advances to the step S356 of FIG. 6 similarly to the step S410, except that the subroutine is called up with an argument “Semi-long” as the argument regarding the notification system determination variable irrespective of the current value of the notification system determination variable.

If the displaying of the IP address in “Semi-long” inside the display area is judged to be impossible (S430: NO), the PC 10_1 displays the IP address in the display area in the notational system “Short” (S434). In this step, the PC 10_1 displays the IP address by calling up the subroutine of FIG. 9 and thereafter advances to the step S356 of FIG. 6 similarly to the step S410, except that the subroutine is called up with an argument “Short” as the argument regarding the notification system determination variable irrespective of the current value of the notification system determination variable.

(5) Parameter Display Process

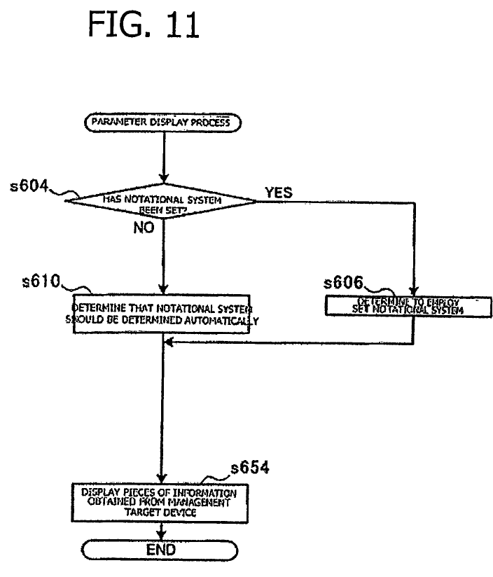

In the following, the details of the parameter display process (S112 of FIG. 2) will be explained referring to a flow chart of FIG. 11.

First, the PC 10_1 checks whether a notational system for IP addresses (IPv6 addresses) has been set or not (S604) similarly to the step S304 of FIG. 6.

If a notational system has been set (S604: YES), the PC 10_1 determines to employ the notational system (set by the user) for displaying an IP address in a subsequent step (namely, in step S654) (S606) similarly to the step S306 of FIG. 6, and thereafter advances to step S654.

On the other hand, if no notational system has been set (S604: NO), the PC 10_1 determines that the notational system for displaying the IP address in the subsequent step should be determined automatically (S610) similarly to the step S310 of FIG. 6, and thereafter advances to the step S654.

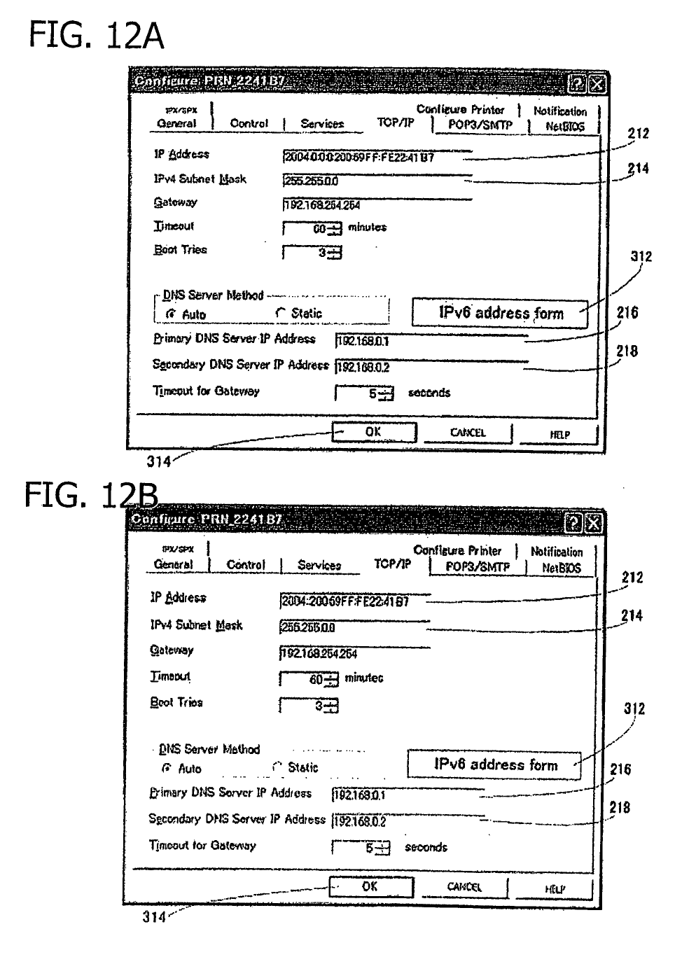

In the step S654, the PC 10_1 displays pieces of information obtained from the management target device in the previous step S110 (see FIG. 2) in corresponding display areas, and thereafter ends the parameter display process. In this step, the pieces of information obtained from the management target device are successively entered in corresponding display areas, in which the IP address is displayed according to the “address display process” which has been explained above. Incidentally, the “address display process” executed in the step S654 for displaying the IP address is slightly different from the “address display process” (see FIG. 8) executed in the step S354 of FIG. 6, in that the “address display process” executed in the step S654 advances from S406 to S412 skipping S408 and S410 when the judgment of S406 is “YES”. Since other steps are the same as those in FIG. 8, repeated description thereof is omitted here. Incidentally, FIG. 4B shows a case where the IP address (IPv6 address) is displayed in the input window 212 of the second screen in the notational system “Long” (S514 of FIG. 9) when the “address display process” is executed in the step S654 of FIG. 11. FIG. 12A shows a case where the IP address is displayed in the input window 212 in the notational system “Semi-long” (S518 of FIG. 9). FIG. 12B shows a case where the IP address is displayed in the input window 212 in the notational system “Short” (S522 of FIG. 9).

As described above, the PC 10_1 configured as above is capable of displaying each IP address (IPv6 address) in a notational system suitable for the size of each display area (for displaying the IP address) on the screens displayed in the steps S102 and S112 of FIG. 2.

IPv6 specifies a number of notational systems for describing each IPv6 address in a reduced number of characters, as mentioned above. With such notational systems, even when the size of a display area for displaying an IP address is insufficient for the maximum number of characters of the IP address, the whole IP address can be displayed inside the display area in most cases using such an abbreviated notational system.

In the steps S426-S434 of FIG. 8, the IP address is displayed in a notational system suitable for the size of the display area for the IP address. Specifically, a notational system of a higher compression ratio (“Short”>“Semi-long”>“Long”) is employed as the display area gets smaller, by which all the characters forming the IP address can be displayed inside the display area without fail as long as the IP address is in a format allowing for the reduction of the number of characters by such compression ratios.

Therefore, the user, being consistently capable of checking all the characters of each IP address at a glance, is relieved of the need of moving the IP address in the display area (by scrolling right/left) in order to view all the characters, by which the usability is enhanced considerably.

In the address form process of FIG. 5, the user can select a notational system for IPv6 addresses by selecting a radio button and/or a check box so that the IPv6 addresses will be displayed according to the selection. Therefore, when the user is expecting to use the screens displayed in the steps S102 and S112 of FIG. 2 (list display screen, setting screen) mainly for checking IP addresses, the user can previously specify that the IP addresses should be displayed automatically in an optimum notational system (by selecting the “Auto” button 412 or leaving the address form screen of FIG. 4C in the initial state). On the other hand, when the user is not expecting to use the screens mainly for checking IP addresses, the user can previously designate a favorite notational system as the particular notational system. Therefore, a user interface capable of flexibly meeting various requirements of the user can be realized. For example, even when the user tends to frequently change parameters other than IP addresses and checks such parameters (rather than IP addresses) frequently, the above configuration is expected to enhance the usability to the user.

In the steps S418-S424 of FIG. 8 (in the case where the setting for displaying an IPv6 address in a number of notational systems simultaneously in a display area has been made), each IP address can be displayed in a corresponding display area in two different notational systems simultaneously (S420, S424) as long as the display area has a size sufficient for the simultaneous displaying (additional displaying).

In the list display process of FIG. 6, when the setting for unifying the notational system for IP addresses has been made (S308: YES), the process of FIG. 7 (steps S312-S332) employs a notational system having the lowest compression ratio among the notational systems capable of fully displaying every one of the IP addresses (to be displayed on the list display screen) inside a corresponding display area, as the notational system to be used for displaying all the IPv6 addresses in the process of S352-S356 of FIG. 6. By the unification, the IP addresses of the information source devices can be displayed in corresponding display areas on the list display screen in the step S354 of FIG. 6 (specifically, S410 of FIG. 8) uniformly in the same notational system determined as above.

Meanwhile, when a notational system has been set (S304: YES), the PC 10_1 determines to employ the notational system (set by the user) for displaying all the IP addresses (IPv6 addresses) on the list display screen (S306). By the determination, the IP addresses of the information source devices can be displayed in corresponding display areas on the list display screen in S354 of FIG. 6 (specifically, S410 of FIG. 8) (uniformly) in the notational system set by the user.

When the setting for unifying the notational system for IP addresses has not been made (S308: NO), the PC 10_1 determines to display each of the IP addresses on the list display screen in a notational system determined automatically (S310). By the determination, the IP addresses of the information source devices can be displayed in corresponding display areas on the list display screen in S354 of FIG. 6 (specifically, S410 of FIG. 8) in notational systems determined automatically for the IP addresses respectively. Therefore, the IP addresses can be displayed in notational systems different from one another.

Whether to display each IP address (on the list display screen in S354 of FIG. 6) in a notational system of the lowest compression ratio among the notational systems capable of fully displaying every one of the IP addresses inside a corresponding display area, in the notational system set by the user, or in a notational system determined automatically can be designated by the user in the steps S204-S210 of FIG. 5 (address form process) as mentioned above.

Modifications

While a description has been given above of a preferred embodiment in accordance with the present invention, the present invention is not to be restricted by the particular illustrative embodiment and a variety of modifications, design changes, etc. are possible without departing from the scope and spirit of the present invention described in the appended claims.

For example, while the information display program and the setting management program (for executing the processes for the setting management) have been assumed to be installed in the PC 10_1 in the above embodiment, the programs may also be installed in a PC 10 other than the PC 10_1 or a device of a different type. It is also possible to install the programs in two or more PCs 10 in the network system (e.g. the PCs 10_1 and 10_2) so as to let the PCs 10 execute the setting management cooperatively, as long as information is properly shared among the PCs. Further, the management target devices are not limited to the printers 20; it is also possible to let the PC 10_1 manage PCs 10 (including the PC 10_1 itself) in the network system as management target devices.

While IPv6 is employed in the above embodiment as an example of a protocol in which a number of notational systems for IP addresses have been specified, the protocol is not restricted to IPv6. IP addresses of other protocols available in the future can also be displayed by the information display device in accordance with the present invention as long as a number of notational systems for IP addresses are specified.

While the notational system is changed (depending on the size of the display area) for each IP address assigned to each management target device (or information source device) in the above embodiment, the notational system may also be changed for other IP addresses that are necessary for realizing communication via the network according to IPv6, such as the IP addresses of the DNS servers 50_1 and 50_2, the IP address of the gateway 30 and the IP address of the mail server 40.

While each IP address is displayed in two notational systems simultaneously in a display area in the steps S418-S424 of FIG. 8 in the above embodiment, each IP address may also be displayed in three notational systems simultaneously on condition that the display area is large enough.

While two IP addresses (the same IP address displayed in two notational systems simultaneously) are arranged horizontally (side by side) in the steps S418-S424 of FIG. 8 in the above embodiment, it is also possible to let the PC 10_1 check whether the display area for displaying the two IP addresses (having a prescribed height on the screen shown in FIG. 3 or FIG. 4) can accommodate the two IP addresses arranged vertically (in parallel or in two lines) and actually display the two lines of IP addresses in different notational systems in the display area on condition that the display area can accommodate the two IP addresses arranged vertically.

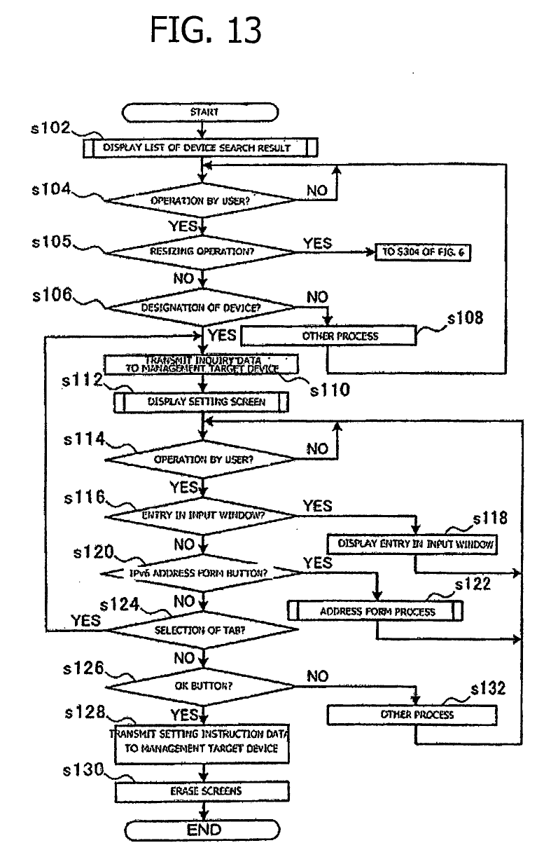

On the list display screen which is displayed in the step S102 of FIG. 2, it is generally possible to arbitrarily change the size (width) of each display area for each type of information, by performing a prescribed operation on the input unit 18. Therefore, the displaying of IP addresses may be redone in response to such a resizing operation as below. FIG. 13 is a flow chart showing a manual setting process in accordance with another embodiment of the present invention. After displaying the list display screen in the step S102, the PC 10_1 checks whether or not an operation for changing the size (width) of the IP address display area (the “Node Address” area in FIG. 3, FIG. 10A, FIG. 10B or FIG. 10C) has been performed by the user (S105). If no resizing operation has been performed (S105: NO), the PC 10_1 advances to the step S106. If the resizing operation has been performed (S105: YES), the PC 10_1 advances to the step S304 of FIG. 6.

With the above configuration, the process from S304 of FIG. 6 is redone each time the size of the IP address display area is changed on the list display screen, by which the IP addresses can be redisplayed in appropriate notational systems on every resizing operation.

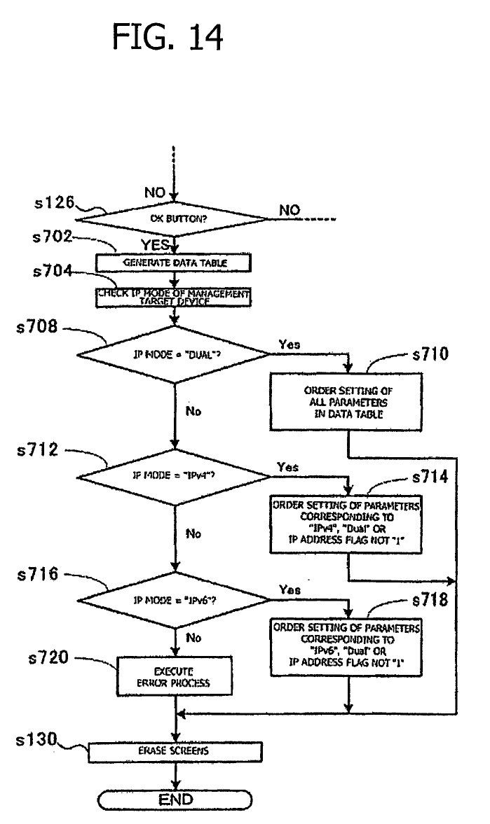

While the PC 10_1 in the step S128 of FIG. 2 instructs the management target device to make the setting of all the parameters (hereinafter also referred to as “usage parameters”) entered in the input windows on all the subscreens of the setting screen, such a setting instruction may also be issued regarding parameters corresponding to the IP mode of the management target device (i.e. depending on whether the management target device has been configured to execute communication according to IPv4 only, IPv6 only, or both IPv4/IPv6). For this purpose, the step S128 of FIG. 2 may be modified as shown in FIG. 14.

Referring to FIG. 14, when the judgment in the step S126 is “YES”, the PC 10_1 generates a data table regarding each of the usage parameters entered in the input windows on all the subscreens of the setting screen (S702). In the data table, a “setting target IP mode” (indicating whether each usage parameter is for IPv4, for IPv6, or supported by both IPv4/IPv6) and an “IP address flag” (indicating whether each usage parameter indicates an IP address or not (set to “1” when the parameter indicates an IP address)) are registered while being associated with each usage parameter.

Subsequently, the PC 10_1 checks the IP mode of the management target device (S704). In this step, the PC 10_1 transmits inquiry data (inquiring about the IP mode) to the management target device. Since notification data (indicating the IP mode of the management target device) is sent back from the management target device receiving the inquiry data, the IP mode indicated by the notification data is recognized by the PC 10_1 as the IP mode of the management target device. Incidentally, the check on the IP mode can also be executed by inquiring about the IP mode together with other information in the inquiry of the step S110 of FIG. 2.

After the IP mode of the management target device is determined as above, the PC 10_1 transmits setting instruction data, ordering the setting of usage parameters corresponding to the IP mode determined in the step S704 (out of all the usage parameters registered in the data table), to the management target device.

Specifically, if the IP mode of the management target device is “Dual” (S708: YES), setting instruction data, ordering the setting of all the parameters registered in the data table, is transmitted to the management target device so that all the parameters will be set to (incorporated into) the management target device (S710).

If the IP mode of the management target device is “IPv4” (S708: N0, S712: YES), setting instruction data, ordering the setting of each parameter (registered in the data table) whose “setting target IP mode” is “IPv4” or “Dual” or whose “IP address flag” is not “1” (not indicating an IP address), is transmitted to the management target device so that such parameters will be set to (incorporated into) the management target device (S714).

If the IP mode of the management target device is “IPv6” (S712: N0, S716: YES), setting instruction data, ordering the setting of each parameter (registered in the data table) whose “setting target IP mode” is “IPv6” or “Dual” or whose “IP address flag” is not “1” (not indicating an IP address), is transmitted to the management target device so that such usage parameters will be set to (incorporated into) the management target device (S718). If the IP mode of the management target device is none of the above modes (S716: NO), an error process for dealing with the situation is executed (S720).

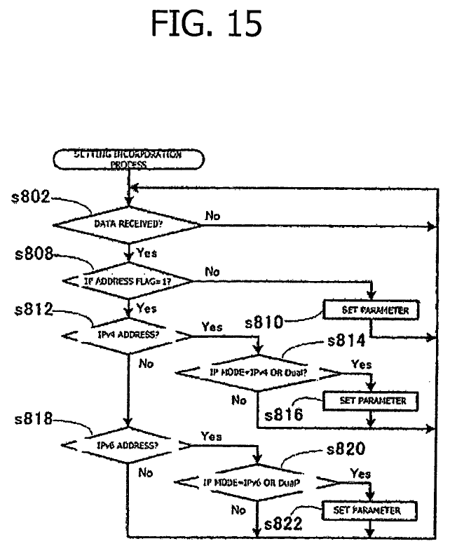

While the management target device is instructed by the setting instruction to set all the usage parameters entered in the input windows on all the subscreens of the setting screen in the step S128 of FIG. 2 and thereby sets all the usage parameters designated by the setting instruction to itself in the above embodiment, the management target device may also be configured to set part of the usage parameters (designated by the setting instruction) corresponding to the IP mode(s) that the management target device has been configured to be able to support. For this purpose, the setting instruction (step S128 of FIG. 2) is issued by the PC 10_1 so as to order the setting of each usage parameter while associating each usage parameter with the “setting target IP mode” and the “IP address flag” similarly to the data table generated in the step S702 of FIG. 14, and the management target device receiving the setting instruction executes a setting incorporation process shown in FIG. 15, for example.

Incidentally, the setting incorporation process of FIG. 15 shows a simple case where the setting instruction designates the setting of only one usage parameter. When the setting instruction designates the setting of two or more usage parameters, the process from step S808 of FIG. 15 is repeated for the usage parameters. Referring to FIG. 15, the management target device first waits until setting instruction data is received (S802). When setting instruction data is received (S802: YES), the management target device checks whether the “IP address flag” associated with a usage parameter included in the setting instruction data is “1” or not (S808). If the “IP address flag” is not “1”, that is, if the usage parameter does not indicate an IP address (S808: NO), the management target device incorporates the usage parameter into its settings (sets the usage parameter to itself) (S810).

If the “IP address flag” associated with the usage parameter included in the setting instruction data is “1”, that is, if the usage parameter indicates an IP address (S808: YES), the management target device checks whether the usage parameter indicating an IP address is a character string of the IPv4 format or not (S812). If the usage parameter (IP address) is in the IPv4 format (S812: YES), the management target device incorporates the usage parameter into its settings (sets the usage parameter to itself) (S816) if the IP mode of the management target device itself has been set to “IPv4” or “Dual” (S814: YES). Thereafter, the management target device returns to the step S802. In other words, in the case where data received via the network is setting instruction data designating the setting of an IPv4 address (S812: YES), the management target device returns to the step S802 without incorporating the usage parameter (IPv4 address) into its settings if the IP mode of the management target device itself has not been set to “IPv4” or “Dual” (S814: NO).

If the usage parameter is not in the IPv4 format (S812: NO), the management target device checks whether the usage parameter indicating an IP address is a character string of the IPv6 format or not (S818). If the usage parameter (IP address) is in the IPv6 format (S818: YES), the management target device incorporates the usage parameter into its settings (S822) if the IP mode of the management target device itself has been set to “IPv6” or “Dual” (S820: YES). Thereafter, the process returns to the step S802. In other words, in the case where data received via the network is setting instruction data designating the setting of an IPv6 address (S818: YES), the management target device returns to the step S802 without incorporating the usage parameter (IPv6 address) into its settings if the IP mode of the management target device itself has not been set to “IPv6” or “Dual” (S820: NO).

What is claimed is:

1. A computer-readable medium having a program stored thereon, said program including computer-readable instructions that cause a device to execute an information display process comprising an information display step of displaying identification information necessary for realizing communication via a network, for which a plurality of notational systems have been specified, in a prescribed display area on a display unit, wherein:
the information display process comprises a check step of checking the size of the display area for displaying the identification information, and
the information display step displays the identification information in a notational system suitable for the size of the display area checked by the check step.

2. The computer-readable medium according to claim 1, wherein:
the information display process further comprises a first notation designation step of letting a user designate which one selected from the notational system suitable for the size checked by the check step and the specified notational systems should be used for displaying the identification information, and
the information display step displays the identification information in the notational system designated in the first notation designation step.

3. The computer-readable medium according to claim 1, wherein the information display step displays the identification information in two or more notational systems simultaneously in the display area when the size checked by the check step is larger than or equal to the sum of sizes of two or more areas each of which is necessary for displaying the identification information in each of the two or more notational systems.

4. The computer-readable medium according to claim 3, wherein:
the information display process further comprises a simultaneous displaying designation step of letting a user designate whether to display the identification information in the display area for the identification information in two or more notational systems simultaneously or not, and
the information display step displays the identification information in two or more notational systems simultaneously in the display area only when the simultaneous displaying of the identification information in two or more notational systems has been designated in the simultaneous displaying designation step.

5. The computer-readable medium according to claim 1, wherein:
the information display step displays a setting screen, used for setting various types of information including the identification information to the device, on the display unit, and
the identification information assigned to the device is displayed by the information display step in a display area which is provided on the setting screen for displaying the identification information.

6. The computer-readable medium according to claim 1, wherein:
the information display process further comprises an information collection step of collecting various types of information from other devices capable of data communication with the device, the various types of information including the identification information assigned to those other devices, and
the information display step displays a list display screen, for displaying the various types of information collected by the information collection step in a list format, on the display unit, and
the identification information assigned to each of those other devices collected by the information collection step is displayed by the information display step in a display area, which is provided on the list display screen for displaying the identification information on each of those other devices.

7. The computer-readable medium according to claim 6, wherein:
the check step conducts the check on the display area regarding each of those other devices, and
the information display step displays the identification information on each of those other devices collected by the information collection step in a notational system suitable for the result of the check by the check step regarding each device.

8. The computer-readable medium according to claim 6, wherein:
the check step conducts the check on the display area regarding each of those other devices, and
the information display step displays the identification information on each of those other devices collected by the information collection step uniformly in one notational system capable of displaying the identification information in the smallest display area among the notational systems suitable for the results of the checks by the check step regarding those other devices.

9. The computer-readable medium according to claim 6, wherein:
the check step conducts the check on the display area regarding each of those other devices, and
the information display process further comprises a second notation designation step of letting a user designate whether the identification information on each of those other devices collected by the information collection step should be displayed in a notational system suitable for the result of the check by the check step regarding each device or uniformly in one notational system capable of displaying the identification information in the smallest display area among the notational systems suitable for the results of the checks by the check step regarding those other devices, and
the information display step displays the identification information on each of those other devices collected by the information collection step in the notational system designated in the second notation designation step.

10. The computer-readable medium according to claim 6, wherein:
the list display screen is configured so that the size of each display area for displaying each piece of the identification information can be changed arbitrarily according to an operation by a user, and
the information display process further comprises a resizing detection step of detecting a change in the size of a display area on the list display screen for displaying the identification information, and
the check on the display areas by the check step and the displaying of the identification information by the information display step are redone when a change is detected by the resizing detection step.

11. An information display device for displaying identification information necessary for realizing communication via a network, for which a plurality of notational systems have been specified, in a prescribed display area on a display unit, comprising:
a check unit which checks the size of the display area for displaying the identification information; and
an information display control unit which controls the display unit to display the identification information in the display area in a notational system suitable for the size of the display area checked by the check unit.

12. An information display method for displaying identification information necessary for realizing communication via a network, for which a plurality of notational systems have been specified, in a prescribed display area on a display unit, comprising:
a check step of checking the size of the display area for displaying the identification information; and
an information display step of letting the display unit display the identification information in the display area in a notational system suitable for the size of the display area checked by the check unit.

13. An information display system for displaying identification information necessary for realizing communication via a network, for which a plurality of notational systems have been specified, in a prescribed display area on a display unit, comprising:
means for checking the size of the display area for displaying the identification information; and
means for displaying said identification information in the display area in a notational system suitable for the size of the display area checked by the check unit.
